(19) United States
(12) Patent Application Publication
(10) Pub. No.: US 2022/0075941 A1
(43) Pub. Date: Mar. 10, 2022

(54) ARTIFICIAL INTELLIGENCE SYSTEM AND METHOD FOR PROVIDING AUTO-COMPLETE SUGGESTIONS

(71) Applicant: BEIJING DIDI INFINITY TECHNOLOGY AND DEVELOPMENT CO., LTD., Beijing (CN)

(72) Inventors: Yiqi Huang, Mountain View, CA (US); Xing Shi, Mountain View, CA (US); Kevin Knight, Mountain View, CA (US)

(73) Assignee: BEIJING VOYAGER TECHNOLOGY CO., LTD., Beijing (CN)

(21) Appl. No.: 17/015,035

(22) Filed: Sep. 8, 2020

(51) Int. Cl. G06F 40/274; G06N 20/00; G06N 7/00

(52) U.S. Cl. CPC G06F 40/274; G06N 7/005; G06N 20/00

(57) ABSTRACT

Embodiments of the disclosure provide artificial intelligence systems and methods for providing auto-complete suggestions. An exemplary artificial intelligence system includes at least one processor configured to receive a portion of a text input by a user through an input device and generate a suggested portion that automatically completes the text. The at least one processor is further configured to determine whether to provide the suggested portion to the user using a learning network. The learning network is trained using reinforcement learning that optimizes a time cost ratio indicative of a time saving when the suggested portion is provided to and accepted by the user. The artificial intelligence system may further include a display configured to display the suggested portion to the user as an auto-complete suggestion in response to a determination by the at least one processor to provide the suggested portion.

### TECHNICAL FIELD

The present disclosure relates to artificial intelligence (AI) systems and methods for providing auto-complete suggestions, and more particularly to, AI systems and methods for providing auto-complete suggestions based on a time cost ratio.

### BACKGROUND

Auto-complete is a technique designed to make user input faster. Auto-complete software is now common in tools like Google™ search or inside programs like Google Gmail™ For example, after a user type “national endowment” in a search bar, the auto-complete software suggests “for the arts,” usually in a different color, in order to complete the term or sentence. If the user finds that the suggestion matches with what she intends to type, she can accept the suggestion by hitting the “tab” key. The auto-complete text “for the arts” then automatically adds to the portion “national endowment” typed by the user to make the complete search term “national endowment for the arts.” By using auto-complete, the user may type faster by accepting automatically suggested text instead of typing all the words. In the example above, “national endowment for the arts” can be typed in 19 keystrokes (18+tab) with auto-complete instead of 31 keystrokes if typed entirely by the user.

In order to be helpful, an auto-complete needs to respond quickly. Every time the user types a key, the auto-complete should make its next suggestion within milliseconds. The auto-complete suggestion should also be accurate. Users have to read each auto-complete suggestion before deciding whether to accept or reject the suggestion. In order not to waste the user's time or add to the user's cognitive load, auto-completers usually have a built-in confidence mechanism. If the auto-completer is not confident about its suggestion at any given point, it may withhold the suggestion. The existing confidence mechanisms are, however, suboptimal as they focus mainly on the likelihood that the suggested text will be accepted. For example, the auto-completer returns a per-word probability score along with its suggestion, and the suggestion may be shown to the user if the probability is greater than this threshold. These mechanisms ignore other important factors that may favor withholding the suggestion. For example, the length of the suggested text affects the user-time spent reading and rejecting suggestions and the user-time saved by accepting suggestions.

Embodiments of the disclosure address the above problems by providing improved artificial intelligence systems and methods for providing auto-complete suggestions based on an improved metric, e.g., a time cost ratio.

### SUMMARY

Embodiments of the disclosure provide an artificial intelligence system for providing auto-complete suggestions. The artificial intelligence system includes at least one processor configured to receive a portion of a text input by a user through an input device and generate a suggested portion that automatically completes the text. The at least one processor is further configured to determine whether to provide the suggested portion to the user using a learning network. The learning network is trained using reinforcement learning that optimizes a time cost ratio indicative of a time saving when the suggested portion is provided to and accepted by the user. The artificial intelligence system may further include a display configured to display the suggested portion to the user as an auto-complete suggestion in response to a determination by the at least one processor to provide the suggested portion.

Embodiments of the disclosure further provide an artificial intelligence method for providing auto-complete suggestions. The artificial intelligence method includes receiving a portion of a text input by a user through an input device and generating, by at least one processor, a suggested portion that automatically completes the text. The artificial intelligence method further includes determining, by the at least one processor, whether to provide the suggested portion to the user using a learning network. The learning network is trained using reinforcement learning that optimizes a time cost ratio indicative of a time saving when the suggested portion is provided to and accepted by the user. The artificial intelligence method also includes displaying, on a display, the suggested portion to the user as an auto-complete suggestion in response to a determination to provide the suggested portion.

Embodiments of the disclosure further provide a non-transitory computer-readable medium having instructions stored thereon that, when executed by at least one processor, causes the at least one processor to perform an artificial intelligence method for providing auto-complete suggestions. The artificial intelligence method includes receiving a portion of a text input by a user through an input device and generating a suggested portion that automatically completes the text. The artificial intelligence method further includes determining whether to provide the suggested portion to the user using a learning network. The learning network is trained using reinforcement learning that optimizes a time cost ratio indicative of a time saving when the suggested portion is provided to and accepted by the user. The artificial intelligence method also includes displaying the suggested portion to the user as an auto-complete suggestion in response to a determination to provide the suggested portion.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary system for providing auto-complete suggestions, according to embodiments of the disclosure.

FIG. 2 illustrates a flowchart of an exemplary method for training a learning network using reinforcement learning for providing auto-complete suggestions, according to embodiments of the disclosure.

FIG. 3 illustrates an exemplary decision process of reinforcement learning, according to embodiments of the disclosure.

FIG. 4 illustrates a schematic diagram of an exemplary user device for interaction with a user, according to embodiments of the disclosure.

FIG. 5 illustrates a block diagram of an exemplary Artificial Intelligence (AI) system for providing auto-complete suggestions, according to embodiments of the disclosure.

FIG. 6 illustrates a flowchart of an exemplary method for providing auto-complete suggestions, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Consistent with present disclosure, artificial intelligence systems and methods for providing auto-complete suggestions are provided. The auto-complete suggestions can be provided for various applications, such as completing customer service dialogues and generating dialogue summaries for a ride-hailing service platform. An exemplary artificial intelligence system includes at least one processor configured to receive a portion of a text input by a user through an input device. For example, the user may be a customer service representative having a dialogue with a customer (e.g., a ride-hailing passenger) using the online chat option. The customer may provide certain information and raise an issue for the representative to resolve. The representative may start typing some text in response. The at least one processor may generate a suggested portion that automatically completes the text that the representative is typing. In some embodiments, the suggested portion may be created by a machine learning model trained with dialogue data in similar contexts. For example, the suggested portion may include a solution or an offer to resolve the raised issue.

The at least one processor is further configured to determine whether to provide (or “trigger”) the suggested portion to the user. In some embodiments, the suggested portion may not be triggered and withheld from being displayed to the user if it does not meet a predetermined metric. In some embodiments, the decision whether to trigger the suggested portion may be made using a learning network. In some embodiments, the learning network is trained using reinforcement learning that optimizes a time cost ratio indicative of a time saving when the suggested portion is provided to and accepted by the user. For example, the time cost ratio can be determined as a ratio between a first time spent by the user when the suggested portion is displayed and accepted and a second time spent by the user to manually input the suggested portion. In some embodiments, the first time spent by the user may be measured by a number of keystrokes equivalent to a review time to read the suggested portion and one additional keystroke to accept the suggested portion. The second time spent by the user can be measured by a number of keystrokes needed to manually input the suggested portion.

In some embodiments, the at least one processor is further configured to train the learning network based on pairs of context texts and corresponding completion texts that are entered or accepted by users to complete the context texts. For example, existing customer service dialogues can be used as the training data. To train the learning network using reinforcement learning, the at least one processor may construct an environment for a virtual agent using the pairs of training data. For each pair of context text and completion text, a current state is determined for the virtual agent at each current time step in the decision process based on the context text and an entered portion of the completion text. Then an auto-complete suggestion is generated for the current state, e.g., using the machine learning model. An action regarding whether to accept the auto-complete suggestion is taken, and the virtual agent receives a reward accordingly. For example, if the auto-complete suggestion does not match the unentered portion of the completion text, the virtual agent receives a negative value as the reward. Otherwise, if the auto-complete suggestion matches the unentered portion of the completion text, the virtual agent receives the associated time cost ratio as the reward. The learning network is trained by maximizing the accumulated reward received by the virtual agent at the next state.

By using the time cost ratio as the optimization target by the learning network, the disclosed auto-complete systems and methods use a confidence mechanism that balances the accuracy and the efficiency of the suggestion. It avoids providing the auto-complete suggestion when the potential burden to the user (e.g., to read the suggested text and decide against it) outweighs the potential time saving (e.g., to accept the suggested text without having to type it in).

The artificial intelligence system may further include a display configured to display the suggested portion to the user as an auto-complete suggestion in response to a determination by the at least one processor to provide the suggested portion. In some embodiments, the auto-complete suggestion can be provided in a particular color that differentiates from the text typed in by the user. The user may accept the suggestion by pressing a key (e.g., the “tab” key or the “enter” key”) or reject the suggestion by continuing with its own typing. In some embodiments, if the auto-complete suggestion is accepted, the pair of the portion of the text input by the user and the suggested portion may be added to the training data for update the learning network. If the suggestion is rejected, the at least one processor may receive the next character typed by the user, and repeats the same process to provide the next auto-complete suggestion until the suggestion is accepted or the user finishes typing the entire text manually.

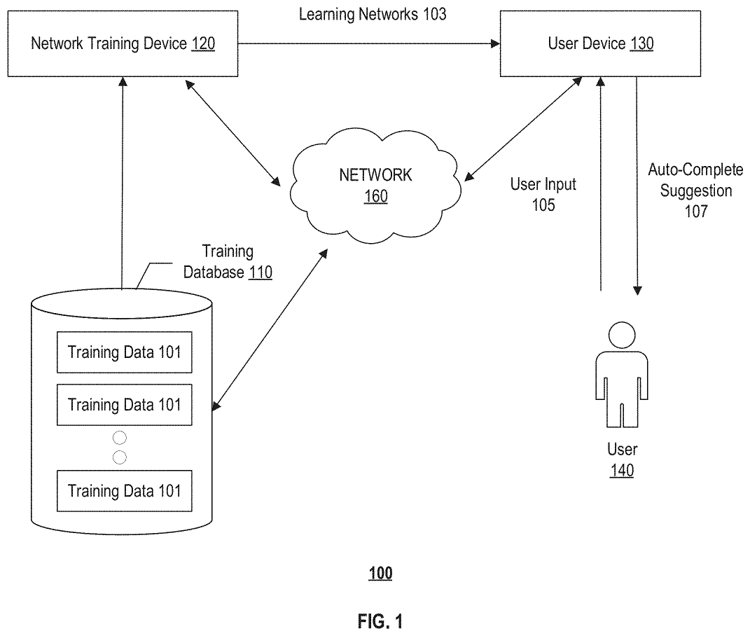

FIG. 1 illustrates a schematic diagram of an exemplary system 100 for providing auto-complete suggestions, according to embodiments of the disclosure. Consistent with the present disclosure, system 100 is configured to provide auto-complete suggestion 107 based on content (e.g., user input 105) entered by user 140 based on one or more learning networks 103 trained using sample pairs of context texts and corresponding completion texts that are entered or accepted by users to complete the context texts (e.g., included in training data 101). In some embodiments, system 100 may include components shown in FIG. 1, including a training database 110, a network training device 120, and a user device 130. It is contemplated that system 100 may include more or less components compared to those shown in FIG. 1.

System 100 may optionally include network 160 to facilitate the communication among the various components of system 100, such as training database 110 and devices 120 and 130. For example, network 160 may be a local area network (LAN), a wireless network, a cloud computing environment (e.g., software as a service, platform as a service, infrastructure as a service), a client-server, a wide area network (WAN), etc. In some embodiments, network 160 may be replaced by wired data communication systems or devices.

In some embodiments, the various components of system 100 may be remote from each other or in different locations, and be connected through network 160 as shown in FIG. 1. In some alternative embodiments, certain components of system 100 may be located on the same site or inside one device. For example, training database 110 may be located on-site with or be part of network training device 120. As another example, network training device 120 and user device 130 may be inside the same computer or processing device.

As shown in FIG. 1, system 100 may include components for performing two stages, a training stage and a diagnosis stage. To perform the training stage, system 100 may include training database 110 and network training device 120. To perform the diagnosis stage, system 100 may include user device 130. In some embodiments, when one or more learning networks (e.g., learning networks 103) for providing auto-complete suggestions are pre-trained, system 100 may only include user device 130.

In some embodiments, training data 101 stored in training database 110 may be used by network training device 120 to train learning networks 103. For example, training data 101 may include sample pairs of context texts and corresponding completion texts. The corresponding completion texts may be entered or accepted by users to complete the context texts. In some embodiments, the learning may be context specific. Accordingly, training data 101 used for training the learning networks may be obtained from the same context that the learning is supposed to apply. For example, if the learning networks are to provide auto-complete suggestions in a customer service dialogue setting, training data 101 used are collected from that same setting.

Network training device 120 may be implemented with hardware specially programmed by software that performs the training process. For example, network training device 120 may include a processor and a non-transitory computer-readable medium. The processor may conduct the training by performing instructions of a training process stored in the computer-readable medium. Network training device 120 may additionally include input and output interfaces to communicate with training database 110, network 160, and/or a user interface (not shown). The user interface may be used for selecting sets of training data, adjusting one or more parameters of the training process, selecting or modifying a framework of the learning network, and/or manually or semi-automatically providing the completion text associated with a sample context text for training.

In some embodiments, learning networks 103 may include an auto-complete generation network that generates a suggested portion that automatically complete the text portion (e.g., in user input 105) entered by user 140. The auto-complete generating network, also known as an auto-complete decoder, may be trained using supervised learning based on the sample context texts and corresponding completion texts in training data 101 to provide an accurate auto-complete prediction. In some embodiments, the auto-complete decoder also returns a per-word probability score along with its auto-complete suggestion. The higher this probability, the more the decoder prefers its top auto-completion over other auto-completions that it considers.

In some embodiments, learning networks 103 may additionally include an auto-complete triggering decider that decides whether to provide the suggested portion generated by the auto-complete decoder as an auto-complete suggestion to user 140. If all suggestions generated by the auto-complete generation network are shown to user 140, the user will be cognitively burdened to read them all, and the auto-completer may actually slow the user down, rather than speeding them up. In some embodiments, the auto-complete triggering decider may be constructed based on the auto-completer' s per-word probability. For example, the decider places a threshold on the per-word probability, and only provide the suggestion to the user if the probability is greater than this threshold. In some alternative embodiments, the decider may additionally take into consideration the length of the suggestion generated by the auto-completer. Suggestions of long sequences are less likely to be accepted than short ones. In some other embodiments, other than the per-word probability and suggestion-length, the decider may further consider number of characters typed by the user so far. The decider is constructed to be more confident (e.g., more likely to trigger the suggestion) if the user has typed a more characters. For example, if the user has typed zero characters so far, the decoder may have a strongly favored auto-completion, but the decider will reduce its confidence in providing it to the user.

In some embodiments consistent with the present disclosure, the auto-complete triggering decider may be a learning network (i.e., an auto-complete triggering network). In some embodiments, the auto-complete triggering network may be a classifier that labels the generated suggestion with binary labels (e.g., “positive” if the decision is to provide the auto-complete suggestion or “negative” if the decision is not to provide the suggestion). For example, the classifier may be trained through supervised learning by optimizing the accuracy on the task of labeling the suggestion. In some embodiments, “training” learning network is the process of determining parameters of the learning network. For example, with certain learned parameters, the auto-complete triggering network may obtain 81% accuracy, while with another set of parameters, 87% accuracy. In that case, the latter parameter values are preferred. Machine learning is used to traverse the infinite ranges of parameter setting efficiently, settling on the ones it can find that have the best accuracy.

In some embodiments consistent with the present disclosure, the auto-complete triggering network may be training using reinforcement learning. In some embodiments, the reinforcement learning optimizes the time cost ratio as the accumulated reward for its decision process. In some embodiments, the auto-complete generating network and the auto-complete triggering network may be trained jointly. In some other embodiments, learning network 103 may be an integrated network that can perform an end-to-end function to provide or not provide an automatically generated auto-complete suggestion.

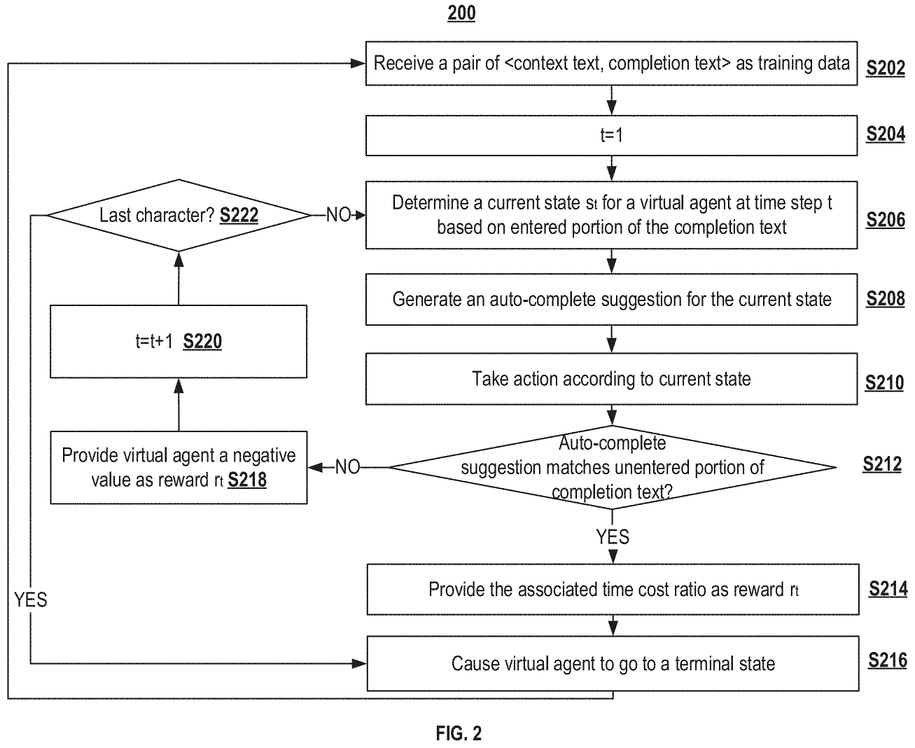

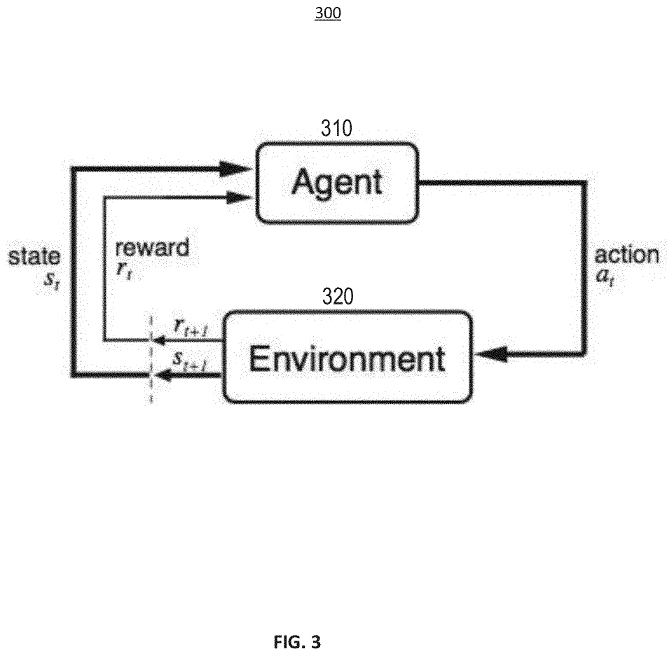

FIG. 2 illustrates a flowchart of an exemplary method 200 for training a learning network using reinforcement learning for providing auto-complete suggestions, according to embodiments of the disclosure. Method 200 may include steps S202-S222 performed by network training device 120. It is to be appreciated that some of the steps may be optional to perform the disclosure provided herein. Further, some of the steps may be performed simultaneously, or in a different order than shown in FIG. 2. In order to train the learning network using reinforcement learning, method 200 may simulate a decision process performed by a virtual agent in an environment over a number of discrete time steps. FIG. 3 illustrates an exemplary decision process 300 of reinforcement learning, according to embodiments of the disclosure. FIG. 2 and FIG. 3 will be described together.

Network training device 120 may receive training data 101 including sample pairs of context text and its corresponding completion text that completes the context text. For example, each pair may be extracted from a dialogue between a ride-hailing customer service representative and a passenger, wherein the context text may include the message entered by the passenger and the completion text may be the message typed by the representative in response. As another example, training data 101 may include pairs of dialogues and their corresponding summaries. Network training device 120 may split each dialog summary into several utterances by punctuation marks, thus constructing <dialogue, utterance> pairs as training data.

As shown in FIG. 3, during decision process 300, a virtual agent 310 interacts with an environment 320. Network training device 120 may construct environment 320 using training data 101. At each time step t, virtual agent 310 receives a state sₜ and selects an action aₜ from a set of possible actions, according to its policy π, where π is a mapping from states sₜ to actions aₜ. In return, virtual agent 310 receives the next state sₜ₊₁ and receives a scalar reward rₜ. Decision process 300 continues until virtual agent 310 reaches a terminal state after which decision process 300 restarts. The return Rₜ is the total accumulated return from time step t with discount factor γ ϵ (0, 1]. The goal of virtual agent 310 during decision process 300 is to maximize the expected return from each state sₜ₊₁.

Accordingly, to train the reinforcement learning network, network training device 120 may receive a pair of <context text, completion text> as training data in step S202 and set the time step t=1 in step S204. In the process of typing the message/utterance, the time step t represents the situation that, after characters c₀-cₜ₋₁ is typed, virtual agent 310 is going to type the t-th character in the message/utterance. For example, in the pair of <context text, completion text> received in step S202, the context text may be a message “My ride request was canceled by the driver after he called me to ask where I am going” entered by the passenger, and the completion text may be the message “Sorry to hear this experience and we will investigate it” entered by the customer service representative in response. Accordingly, at time step t=15, e.g., characters “Sorry to hear this” are typed by the representative.

In step S206, network training device 120 may determine a current state sₜ for virtual agent 310 at time step t based on the entered portion of the completion text, e.g., characters c₀-cₜ₋₁. In some embodiment, state sₜ may include quantifiable features of context text and the entered portion of the completion text such as its length of prefix, length of auto-complete completion suggestion, completion confidence score, etc.

In step S208, network training device 120 may apply the auto-complete decoder to generate an auto-complete suggestion for the current state. In the example above, at time step t=15, after “Sorry to hear this” are typed by the representative, the auto-complete decoder may generate “experience and we will investigate it” as the auto-complete suggestion for the current state. Alternatively, the auto-complete decoder may generate “incident and thank you for reporting it” as the suggestion.

In step S210, network training device 120 may map the current state sₜ to an action aₜ. In some embodiments, the mapping may be performed by applying the auto-complete triggering learning network with its current parameters to the current state sₜ. The action may be selected from the action space of [trigger, not trigger]. In other words, network training device 120 determines whether to provide the auto-complete suggestion to virtual agent 310.

In step S212, network training device 120 may compare the auto-complete suggestion with the unentered portion of the completion text in the training data. Based on the comparison, virtual agent 310 will receive a reward accordingly. In the example above, at time step t=15, the unentered portion of the completion text is “experience and we will investigate it.” Therefore, if the auto-complete suggestion generated by the decoder matches the unentered portion (S212:YES), e.g., both are “experience and we will investigate it,” method 200 proceeds to step S214, where virtual agent 310 accepts the auto-complete suggestion and receives a time cost ratio as the reward rₜ.

Consistent with the present disclosure, time cost ratio is a metric indicative of a time saving when the suggested portion is provided to and accepted by the user (e.g., virtual agent 310 during training). For example, the time cost ratio can be determined as a ratio between a first time spent by the user when the suggested portion is displayed and accepted and a second time spent by the user to manually input the suggested portion. Using “experience and we will investigate it” as the exemplary auto-complete suggestion, the first time spent by the user includes a review time for virtual agent 310 to read this suggested portion and a time to accept the suggested portion (by clicking or entering a key). The second spent by the user is the time for virtual agent 310 to type the exact characters “experience and we will investigate it.”

In some embodiments, the first time and second time spent by the user may be measured by keystrokes. For example, the first time may be approximated by a number of keystrokes equivalent to the review time and one additional keystroke to accept the suggested portion. In the above example, assuming the speed of reading 10 characters in the suggestions is equivalent to typing 1 character, the first time for reviewing and accepting the auto-complete suggestion “experience and we will investigate it” is 32 characters*0.1 keystroke/character+1 keystroke=4.2 keystrokes. Similarly, the second time spent by the user can be measured by the number of keystrokes needed to manually input the suggested portion, which is 32 characters+5 spaces=37 keystrokes. Therefore, the time cost ratio in this case is 4.2/37=11.35%. In some embodiments, after the auto-complete-trigger system operating in the real production environment, the real time cost ratio can be directly retrieved from real users' behaviors.

In step S216, virtual agent 310 may go to a terminal state (sₜ₊₁). Otherwise, if the generated auto-complete suggestion in step S208 does not match the unentered portion (S212:NO), method proceeds to step S218, where virtual agent 310 a negative value as reward rₜ. In other words, the decision to provide an auto-complete suggestion that does not match the ground truth is penalized by a negative reward.

In step S220, network training device 120 updates time step from t to t+1, at which time step virtual agent 310 enters the next character cₜ in the unentered completion text and reaches the next state sₜ₊₁. For example, virtual agent 310 enters the next character “e” in the message. In step S222, network training device 120 determines whether virtual agent 310 types the last character of the unentered portion of the completion text and the message is now complete. If the last character is typed (S222:YES), method 200 proceeds to step S216 where virtual agent 310 goes to the terminal state. Otherwise (S222:No), method 200 repeats S206-S212 for the next time step t+1 of decision process 300 until method 200 proceeds to step S216.

After step S216, where virtual agent reaches the terminal state for the current pair of <context text, completion text>, method 200 returns to step S202 to receive the next pair of <context text, completion text> in the training data to continue constructing environment 320. Network training device 120 performs method 200 and refines parameters of the auto-complete triggering network with the goal for virtual agent 310 to maximize the accumulated return Rₜ₊₁ from each state sₜ₊₁. Network training device 120 provides the trained learning network to user device 130, which applies the learning network on user input 105 for making decisions of providing auto-complete suggestions.

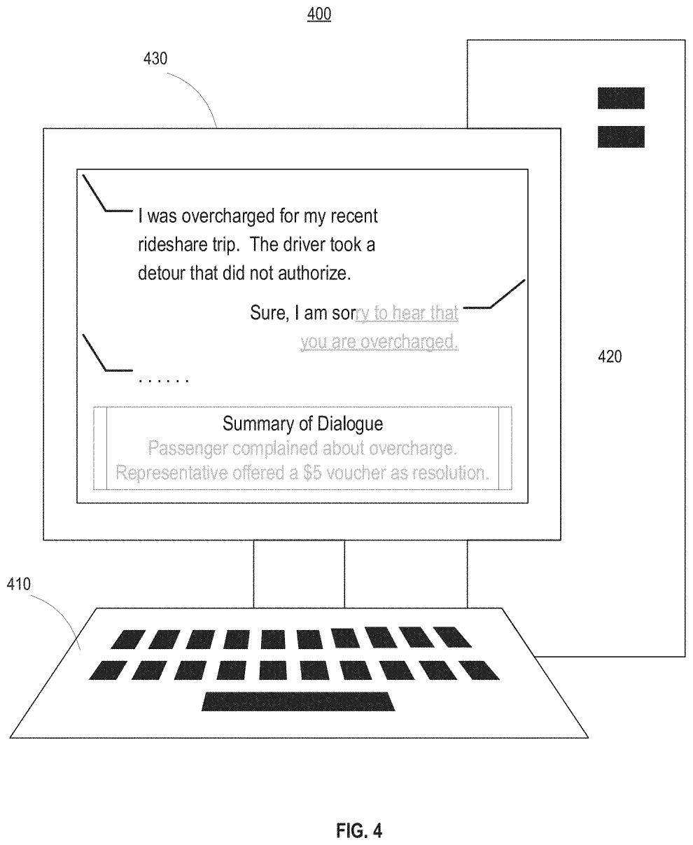

Returning to FIG. 1, consistent with the present disclosure, system 100 may receive user input 105 from user 140 via user device 130. In some embodiments, user device 130 may be a mobile phone, a desktop computer, a laptop, a PDA, a robot, a kiosk, etc. FIG. 4 illustrates a schematic diagram of an exemplary user device 400 for interacting with a user, according to embodiments of the disclosure.

User device 400 may include an input device 410 configured to receive the user input content. In some embodiments, input device 410 may include a keyboard, hard or soft, and/or a mouse, for user 140 to type in the text content (e.g., user input 105). Input device 410 may additionally or alternatively include a touch screen (e.g., as part of a display device 430) for patients to handwrite the text content. If the input is handwriting, user device 400 may automatically recognize the handwriting and convert it to text information. In some other embodiments, input device 410 may include a microphone (not shown), for recording message provided by user 140 orally. User device 400 may automatically transcribe the recorded audio data into texts. In some alternative embodiments, the handwriting recognition and audio transcription may be performed automatically by an Artificial Intelligence (AI) system 420 of user device 400.

The user input content, along with other information, may be displayed on display device 430. Display device 430 may include a display such as a Liquid Crystal Display (LCD), a Light Emitting Diode Display (LED), a plasma display, or any other type of display, and provide a Graphical User Interface (GUI) presented on the display for user input and data depiction. The display may include a number of different types of materials, such as plastic or glass, and may be touch-sensitive to receive inputs from the user. For example, the display may include a touch-sensitive material that is substantially rigid, such as Gorilla Glass™, or substantially pliable, such as Willow Glass™.

In the example shown by FIG. 4, user 140 may be a ride-hailing customer service representative having a dialogue with a passenger using the online chat option, where user input 105 may include proposed resolutions to an issue raised by the passenger. Accordingly, display device 230 may display the customer service dialogue between the passenger and the customer service representation.

Based on the typed texts in the dialogue, AI system 420 of user device 400 may generate a suggested portion that automatically completes the text that the representative is typing. In some embodiments, the suggested portion may be created by the auto-complete generation network of learning networks 103. AI system 420 is further configured to determine whether to provide (or “trigger”) the suggested portion to user 140, e.g., by displaying it on display device 430. In some embodiments, the decision may be made by applying the auto-complete triggering network of learning networks 103.

If AI system 420 decides to provide it, the suggested portion may be displayed user 140. User 140 may accept or reject the suggested portion. After the suggested portion is accepted, the complete text may be displayed as part of the typed portion. Otherwise, user 140 may reject the suggested portion by continuing typing the message. In some embodiments, AI system 420 may continue to determine an updated auto-complete suggestion based on the additional input provided by user 140.

In some embodiments, as in the example shown by FIG. 4, a summary of dialogue may be additionally displayed. Customer service representatives are often required to log a summary for each dialogue. AI system 420 may similarly generate and provide an auto-complete suggestion for the summary based on learning networks 103. Learning networks 103 may include similar components and may be similarly trained, except using sample <dialogue, summary> pairs as training data 101. Similarly, the suggested summary may be displayed in a different manner until accepted by user 140.

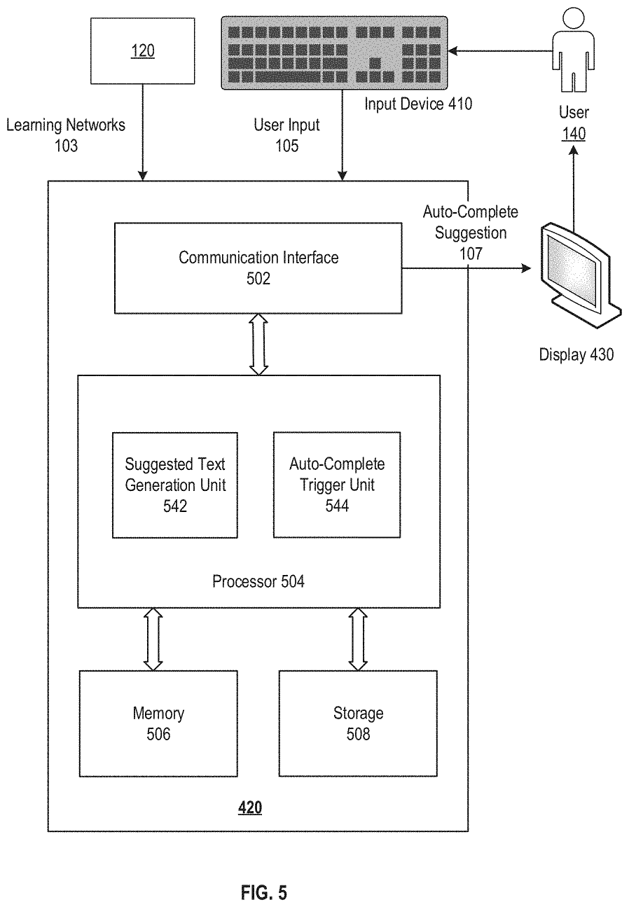

FIG. 5 illustrates a block diagram of an exemplary Artificial Intelligence (AI) system 420 for providing auto-complete suggestions, according to embodiments of the disclosure. In some embodiments, as shown in FIG. 5, AI system 420 may include a communication interface 502, a processor 504, a memory 506, and a storage 508. In some embodiments, AI system 420 may have different modules in a single device, such as an integrated circuit (IC) chip (e.g., implemented as an application-specific integrated circuit (ASIC) or a field-programmable gate array (FPGA)), or separate devices with dedicated functions. In some embodiments, one or more components of AI system 420 may be located in a cloud, or may be alternatively in a single location (such as inside a mobile device) or distributed locations. Components of AI system 420 may be in an integrated device inside user device 130, or distributed at different locations but communicate with each other through a network (not shown). Consistent with the president disclosure, AI system 420 may be configured to provide auto-complete suggestions to user 140 based on user input 105 and learning networks 103 trained by network training device 120.

Communication interface 502 may send data to and receive data from components such as network training device 120 and user device 130 via communication cables, a Wireless Local Area Network (WLAN), a Wide Area Network (WAN), wireless networks such as radio waves, a cellular network, and/or a local or short-range wireless network (e.g., Bluetooth™), or other communication methods. In some embodiments, communication interface 502 may include an integrated services digital network (ISDN) card, cable modem, satellite modem, or a modem to provide a data communication connection. As another example, communication interface 502 may include a local area network (LAN) card to provide a data communication connection to a compatible LAN. Wireless links can also be implemented by communication interface 502. In such an implementation, communication interface 502 can send and receive electrical, electromagnetic or optical signals that carry digital data streams representing various types of information.

Consistent with some embodiments, communication interface 502 may receive user input 105 from user 140 via, e.g., input device 410 of user device 130. Communication interface 502 may further receive learning networks 103 from network training device 120. After AI system 420 determines whether to provide auto-complete suggestions to user 140 by applying learning networks 103 to user input 105, communication interface 502 may provide auto-complete suggestion 107 to user device 130, e.g., for displaying on display device 430.

Processor 504 may include any appropriate type of general-purpose or special-purpose microprocessor, digital signal processor, or microcontroller. Processor 504 may be configured as a separate processor module dedicated to provide auto-complete suggestions. Alternatively, processor 504 may be configured as a shared processor module for performing other functions in addition to auto-complete.

Memory 506 and storage 508 may include any appropriate type of mass storage provided to store any type of information that processor 504 may need to operate. Memory 506 and storage 508 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 506 and/or storage 508 may be configured to store one or more computer programs that may be executed by processor 504 to perform functions disclosed herein. For example, memory 506 and/or storage 508 may be configured to store program(s) that may be executed by processor 504 to provide auto-complete suggestions.

Memory 506 and/or storage 508 may be further configured to store information and data used by processor 504. For instance, storage 508 may be configured to store learning networks 103 including their model parameters. In some embodiments, memory 506 and/or storage 508 may also store intermediate data such as the auto-complete suggestions, their attributes such as lengths, probabilities, etc., and computed metrics values such as time cost ratios. The various types of data may be stored permanently, removed periodically, or disregarded immediately after the data is processed.

As shown in FIG. 5, processor 504 may include multiple modules, such as suggested text generation unit 542, an auto-complete trigger unit 544, and the like. These modules (and any corresponding sub-modules or sub-units) can be hardware units (e.g., portions of an integrated circuit) of processor 504 designed for use with other components or software units implemented by processor 504 through executing at least part of a program. The program may be stored on a computer-readable medium, and when executed by processor 504, it may perform one or more functions. Although FIG. 5 shows units 542 and 544 within one processor 504, it is contemplated that these units may be distributed among different processors located closely or remotely with each other.

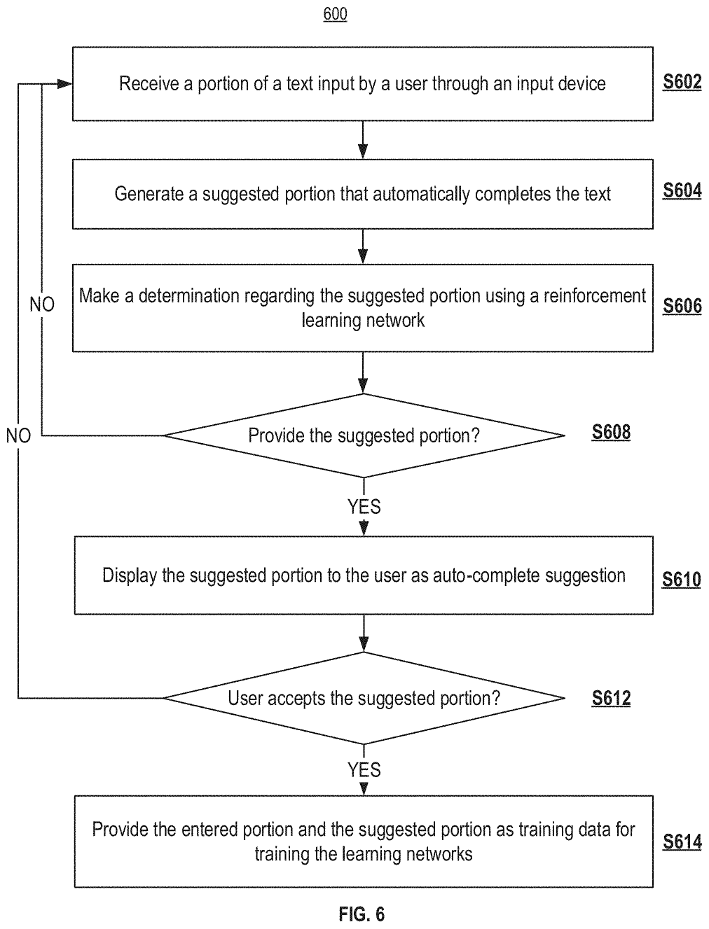

In some embodiments, units 542 and 544 may execute computer instructions to provide auto-complete suggestions. For example, FIG. 6 illustrates a flowchart of an exemplary method 600 for providing auto-complete suggestions, according to embodiments of the disclosure. Method 600 may be implemented by AI system 500 and particularly processor 504 or a separate processor not shown in FIG. 5. Method 600 may include steps S602-S614 as described below. It is to be appreciated that some of the steps may be optional to perform the disclosure provided herein. Further, some of the steps may be performed simultaneously, or in a different order than shown in FIG. 6.

In step S602, communication interface 502 may receive a portion of a text input by user 140 through input device 410. For example, in the customer service dialogue shown by FIG. 4, the passenger may provide a description of the issue by typing a message “I was overcharged for my recent rideshare trip. The driver took a detour that did not authorize”. In response, the customer service representative (e.g., user 140) may start typing some text using input device 410. For example, she might type a portion of a message “Sure, I am sor . . . ” The message typed by the passenger and the portion of message typed by the representative may be displayed on display device 430 in a solid color, e.g., black.

In step S604, suggested text generation unit 542 of processor 504 may generate a suggested portion that automatically completes the user input text. In some embodiments, the suggested portion may be created by the auto-complete decoder of learning networks 103. For example, the suggested portion may include a solution or an offer to resolve the raised issue, such as “ry to hear that you are overcharged,” as shown by FIG. 4.

In step S606, auto-complete trigger unit 544 of processor 504 may make a determination regarding whether to provide (or trigger) the suggested portion. In some embodiments, the decision may be made by applying the auto-complete decider of learning networks 103, such as the auto-complete triggering learning network trained by network training device 120 by performing method 200. For example, auto-complete trigger unit 544 may apply the auto-complete triggering learning network on the suggested text “ry to hear that you are overcharged,” to make a decision that maximizes the time cost ratio.

If auto-complete trigger unit 544 decides to provide the suggested text (S608:YES), the text may be displayed to user 140 on display device 430 as an auto-complete suggestion in step S610. In some embodiments, the suggested portion may be displayed in a different manner compared to the texts actually entered by user 140, in order to indicate to user 140 that it is merely suggested. For example, as shown in FIG. 4, the suggested portion may be displayed in a grey color, as opposed to solid black, and/or underlined. As another example, the suggested portion may be shown in a blurb.

In step S612, user 140 may accept or reject the suggested portion displayed to her. In some embodiments, user 140 may accept the suggested portion using input device 410, e.g., by clicking on the suggested portion or by entering a key on the keyboard, such as the “tab” key or the “enter” key. If user 140 accepts the suggested portion (S612:YES), communication interface 502 may receive a signal indicating the same. After the suggested portion is accepted, the complete text may be displayed in the same manner as the user typed portion. For example, in FIG. 4, the message “Sure, I am sorry to hear that you are overcharged” may be displayed on display device 430 in a solid color as if the entire text is typed by user 140.

If user 140 accepts the auto-complete suggestion (S612:YES), the auto-completed message and its context data (e.g., the message provided by the passenger) can be helpful to enrich the training data used for training the auto-complete decoder and auto-complete triggering network of learning networks 103. Accordingly, in step S614, AI system 420 may provide the entered portion and the suggested portion to training database 110 to be stored as training data 101. In some embodiments, the training data may be later used by network training device 120 to train the auto-complete triggering learning network.

If user 140 rejects the suggested portion (S612:NO), the displayed suggestion may disappear from display device 430. In some embodiments, user 140 may reject the suggestion by continuing typing the message, and method 600 may return to S602 to receive the additional text input by user 140 and repeat steps S602-614 to determine an updated auto-complete suggestion based on the additional input provided by user 140. For instance, in the example shown by FIG. 4, the initial auto-complete suggestion may be “ry about your experience.” User 140 may choose to ignore the suggestion and continue to type the message “Sure, I am sorry to hear . . . ” AI system 420 may then generate and determine to display another auto-complete suggestion, e.g., “that you are overcharged.”

Method 600 may be similarly performed to provide auto-complete suggestions for other applications, provided learning networks 103 are trained for the corresponding applications. For example, method 600 can be performed to provide summaries for customer service dialogues using learning networks 103 trained for that context, such as using sample <dialogue, summary> pairs as training data. As shown in FIG. 4, a suggested text of “Passenger complained about overcharge. Representative offered a $5 voucher as resolution” may be displayed on display device 430, to help the representative to automatically complete the summary.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. An artificial intelligence system for providing auto-complete suggestions, comprising:
at least one processor configured to:
receive a portion of a text input by a user through an input device;
generate a suggested portion that automatically completes the text; and
determine whether to provide the suggested portion to the user using a learning network, wherein the learning network is trained using reinforcement learning that optimizes a time cost ratio indicative of a time saving when the suggested portion is provided to and accepted by the user; and
a display configured to display the suggested portion to the user as an auto-complete suggestion in response to a determination by the at least one processor to provide the suggested portion.

2. The artificial intelligence system of claim 1, wherein the time cost ratio is determined as a ratio between a first time spent by the user when the suggested portion is displayed and accepted and a second time spent by the user to manually input the suggested portion.

3. The artificial intelligence system of claim 2,
wherein the first time spent by the user is measured by a number of keystrokes equivalent to a review time to read the suggested portion and one additional keystroke to accept the suggested portion,
wherein the second time spent by the user is measured by a number of keystrokes needed to manually input the suggested portion.

4. The artificial intelligence system of claim 1, wherein the at least one processor is configured to determine not to provide the suggested portion to the user, wherein the at least one processor is further configured to:
receive an additional character input by the user through the input device;
update the suggested portion that automatically completes the text; and
determine whether to provide the updated suggested portion to the user using the learning network.

5. The artificial intelligence system of claim 1, wherein the at least one processor is further configured to train the learning network based on pairs of context texts and corresponding completion texts that are entered or accepted by users to complete the context texts.

6. The artificial intelligence system of claim 5, wherein to train the learning network using each pair of context text and completion text, the at least one processor is further configured to:
determine a current state for a virtual agent at a current time step in a decision process based on the context text and an entered portion of the completion text;
generate an auto-complete suggestion for the current state;
take an action with respect to providing the auto-complete suggestion to the virtual agent by applying the learning network to the current state; and
cause the virtual agent to receive a reward according to a comparison of the auto-complete suggestion and the unentered portion of the completion text.

7. The artificial intelligence system of claim 6, wherein
if the auto-complete suggestion does not match the unentered portion of the completion text, the virtual agent receives a negative value as the reward; and
if the auto-complete suggestion matches the unentered portion of the completion text, the virtual agent receives the associated time cost ratio as the reward.

8. The artificial intelligence system of claim 7, wherein the at least one processor is configured to maximize an accumulated reward received by the virtual agent at the next state.

9. The artificial intelligence system of claim 5, wherein the at least one processor is further configured to:
receive a confirmation that the user accepts the suggested portion displayed to the user; and
add the pair of the portion of the text input by the user and the suggested portion to the pairs of context texts and corresponding completion texts for training the learning network.

10. An artificial intelligence method for providing auto-complete suggestions, comprising:
receiving a portion of a text input by a user through an input device;
generating, by at least one processor, a suggested portion that automatically completes the text;
determining, by the at least one processor, whether to provide the suggested portion to the user using a learning network, wherein the learning network is trained using reinforcement learning that optimizes a time cost ratio indicative of a time saving when the suggested portion is provided to and accepted by the user; and
displaying, on a display, the suggested portion to the user as an auto-complete suggestion in response to a determination to provide the suggested portion.

11. The artificial intelligence method of claim 10, wherein the time cost ratio is determined as a ratio between a first time spent by the user when the suggested portion is displayed and accepted and a second time spent by the user to manually input the suggested portion.

12. The artificial intelligence method of claim 11,
wherein the first time spent by the user is measured by a number of keystrokes equivalent to a review time to read the suggested portion and one additional keystroke to accept the suggested portion,
wherein the second time spent by the user is measured by a number of keystrokes needed to manually input the suggested portion.

13. The artificial intelligence method of claim 10, wherein the suggested portion is determined not to be provided to the user, wherein the artificial intelligence method further comprises:
receiving an additional character input by the user through the input device;
updating the suggested portion that automatically completes the text; and
determining whether to provide the updated suggested portion to the user using the learning network.

14. The artificial intelligence method of claim 10, further comprising training the learning network based on pairs of context texts and corresponding completion texts that are entered or accepted by users to complete the context texts.

15. The artificial intelligence method of claim 14, wherein training the learning network comprises constructing an environment using each pair of context text and completion text, including:
determining a current state for a virtual agent at a current time step in a decision process based on the context text and an entered portion of the completion text;
generating an auto-complete suggestion for the current state;
taking an action with respect to providing the auto-complete suggestion to the virtual agent by applying the learning network to the current state; and
causing the virtual agent to receive a reward according to a comparison of the auto-complete suggestion and the unentered portion of the completion text.

16. The artificial intelligence method of claim 15, wherein
if the auto-complete suggestion does not match the unentered portion of the completion text, the virtual agent receives a negative value as the reward; and
if the auto-complete suggestion matches the unentered portion of the completion text, the virtual agent receives the associated time cost ratio as the reward.

17. The artificial intelligence method of claim 16, wherein training the learning network further comprises maximizing an accumulated reward received by the virtual agent at the next state.

18. The artificial intelligence method of claim 14, further comprising:
receiving a confirmation that the user accepts the suggested portion displayed to the user; and
adding the pair of the portion of the text input by the user and the suggested portion to the pairs of context texts and corresponding completion texts for training the learning network.

19. A non-transitory computer-readable medium having instructions stored thereon that, when executed by at least one processor, causes the at least one processor to perform an artificial intelligence method for providing auto-complete suggestions, the artificial intelligence method comprising:
receiving a portion of a text input by a user through an input device;
generating a suggested portion that automatically completes the text;
determining whether to provide the suggested portion to the user using a learning network, wherein the learning network is trained using reinforcement learning that optimizes a time cost ratio indicative of a time saving when the suggested portion is provided to and accepted by the user; and
displaying the suggested portion to the user as an auto-complete suggestion in response to a determination to provide the suggested portion.

20. The non-transitory computer-readable medium of claim 19, wherein the artificial intelligence method further comprises training the learning network based on pairs of context texts and corresponding completion texts that are entered or accepted by users to complete the context texts,
wherein training the learning network using a pair of context text and completion text comprises:
determining a current state for a virtual agent at a current time step in a decision process based on the context text and an entered portion of the completion text;
generating an auto-complete suggestion for the current state;
take an action with respect to providing the auto-complete suggestion to the virtual agent by applying the learning network to the current state; and
cause the virtual agent to receive a reward according to a comparison of the auto-complete suggestion and the unentered portion of the completion text.
